(19) United States
(12) Patent Application Publication
(10) Pub. No.: US 2007/0192209 A1
(43) Pub. Date: Aug. 16, 2007

(54) MORTGAGE LOAN ORIGINATION SYSTEM AND METHOD

(76) Inventors: Gerald Anthony Ronan, San Clemente, CA (US); Robert John Oakes, Capistrano Beach, CA (US)

Correspondence Address: LAW OFFICES OF LARRY K. ROBERTS, INC., 2 Park Plaza, Suite 300, Irvine, CA, 92614, US

(21) Appl. No.: 11/675,020

(22) Filed: Feb. 14, 2007

Related U.S. Application Data
(60) Provisional application No. 60/773,526, filed on Feb. 15, 2006.

(51) Int. Cl. G06Q 30/00

(52) U.S. Cl. 705/26

(57) ABSTRACT

A loan origination system and method includes a special button that is placed on a loan Originator's website, a web page linked to the special button with a loan application button provided by a direct lender, a personal assistant provided by the direct lender and assigned to the loan Originator, and an abbreviated loan application which is accessed from the web page, and submitted on-line to the direct lender.

This application claims the benefit of U.S. Provisional Application No. 60/773,526 filed Feb. 15, 2006, hereby incorporated by reference.

### BACKGROUND

Real estate loan originators such as a real estate broker, home builder, small community bank or credit union (the “Originator”) typically spend time and money to generate leads and then refer those leads to a mortgage broker or other lender for the loan. Under the Real Estate Settlement Procedures Act (RESPA) the originator may not accept a referral fee or other compensation for the referral; a commission or fee must be earned.

Under RESPA, the Broker must perform a minimum of five activities in addition to (a) below:

a. Gather information from borrowers to complete a loan application.

b. Educate borrowers as to the home buying and financing process.

c. Advise the borrowers about the different types of loan products available, and show that closing costs and monthly payments vary under each product.

d. Initiate and/or order inspections or engineering reports.

e. Maintain regular contact with borrowers between application and closing in order to apprise them of the status of the loan application and to gather any additional needed information, determine or order a service to determine if the property resides in a floor zone.

f. Participate in the loan closing.

g. Analyze borrowers' income and debt and pre-qualify the prospective borrower to determine the maximum affordable mortgage.

h. Collect financial information (tax returns, bank statements) and other related documents that are part of the application process.

i. Initiate and/or order requests for mortgage and other loan verifications.

j. Initiate and/or order appraisals.

k. Provide required disclosures (such as truth in lending and good faith estimates) to borrowers.

l. Assist borrowers to understand and clear credit problems.

m. Order legal documents.

In the event that Broker performs only counseling-type services as found in (b), (c), (d), (i) and (j) above, then additional conditions apply under RESPA.

In order for Originators to offer mortgage services to their clients, they would first have to set up a mortgage division and establish themselves as a lender. This would require the Originator to dedicate office space, and hire personnel including loan processors, administrative and marketing personnel. In addition the Originator would typically incur expenses to equip the office and staff with furnishings, computers including loan processing software, fax machines, copy machines, desks, etc. A training program would be established and maintained on products and software.

The Originator would then typically apply to wholesale lenders such as banks, savings and loan institutions and other specialty financing institutions to become an approved broker and offer their loan products to consumers. The real estate broker would by necessity maintain multiple relationships with these financial institutions in order to offer the widest variety of loan products at competitive pricing.

This is a time consuming and costly process. Once the Originator goes through all of the above it does not guarantee the product and service offered to the consumer will be of the highest and most competitive. By virtue of the fact that they are a “small shop” with limited volume and resources, the caliber of personnel they can hire and afford as well as the product line they qualify for and can offer would be below that of an established mid-sized wholesale mortgage bank.

### BRIEF DESCRIPTION OF THE DRAWINGS

Features and advantages of the disclosure will readily be appreciated by persons skilled in the art from the following detailed description when read in conjunction with the drawing wherein:

FIG. 1 is a schematic and functional block diagram of an exemplary loan origination system.

FIGS. 1A-1B are simplified flow diagrams illustrative of features of an exemplary method for mortgage loan origination.

FIGS. 2-5B are representative screen shots generated by an exemplary embodiment of a mortgage loan origination system.

FIG. 6 is a representative screen shot generated by an exemplary embodiment of a direct lender's website describing features of a loan origination program and system.

FIGS. 7A-7B are exemplary screen shots of an exemplary alternate loan originator website page.

### DETAILED DESCRIPTION

In the following detailed description and in the several figures of the drawing, like elements are identified with like reference numerals. The figures are not to scale, and relative feature sizes may be exaggerated for illustrative purposes.

An exemplary embodiment of a mortgage brokerage system includes several components, including the following.

A “My Mortgage Division” button that is placed on the Originator's website.

2. A “splash page” with a loan application button provided by a direct lender.

3. A “Personal Assistant” provided by the direct lender.

4. An abbreviated loan application which is accessed from the splash page, and submitted on-line by the client to the direct lender.

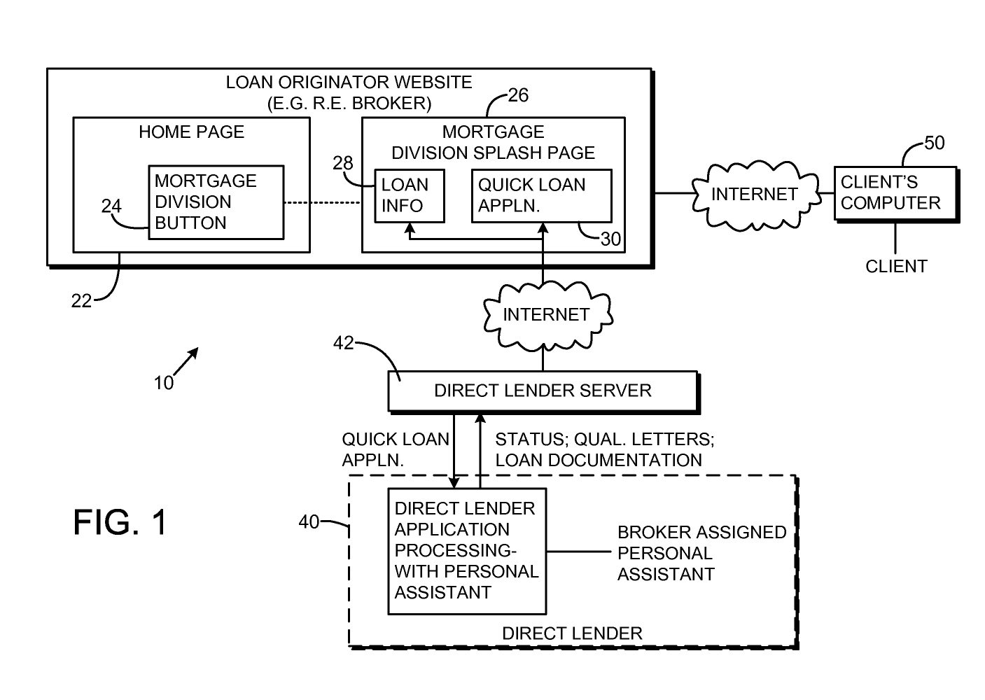

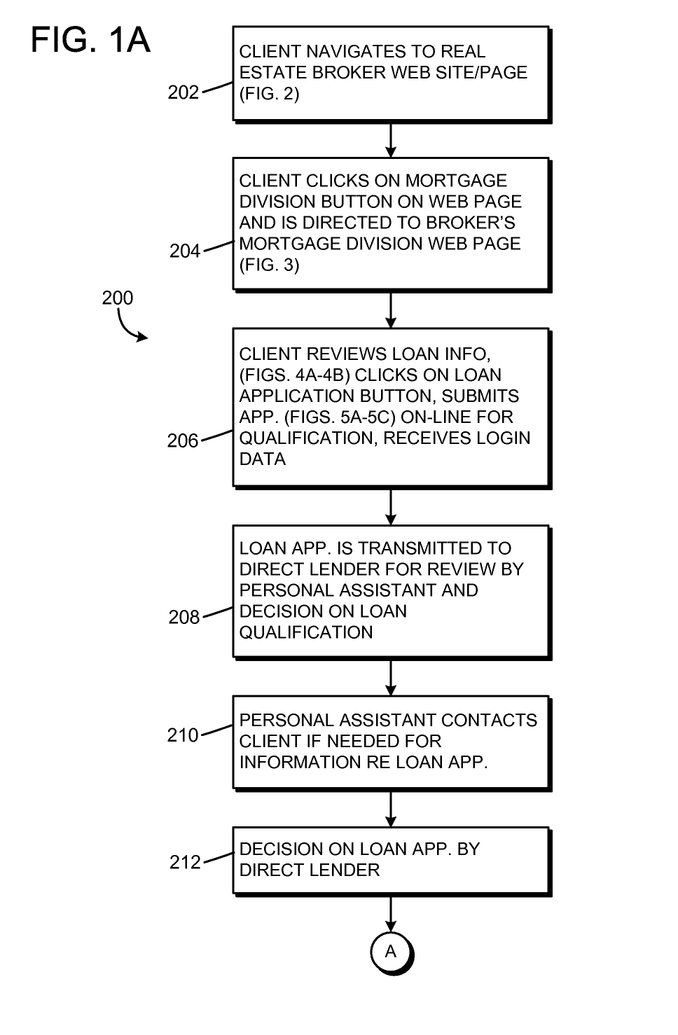

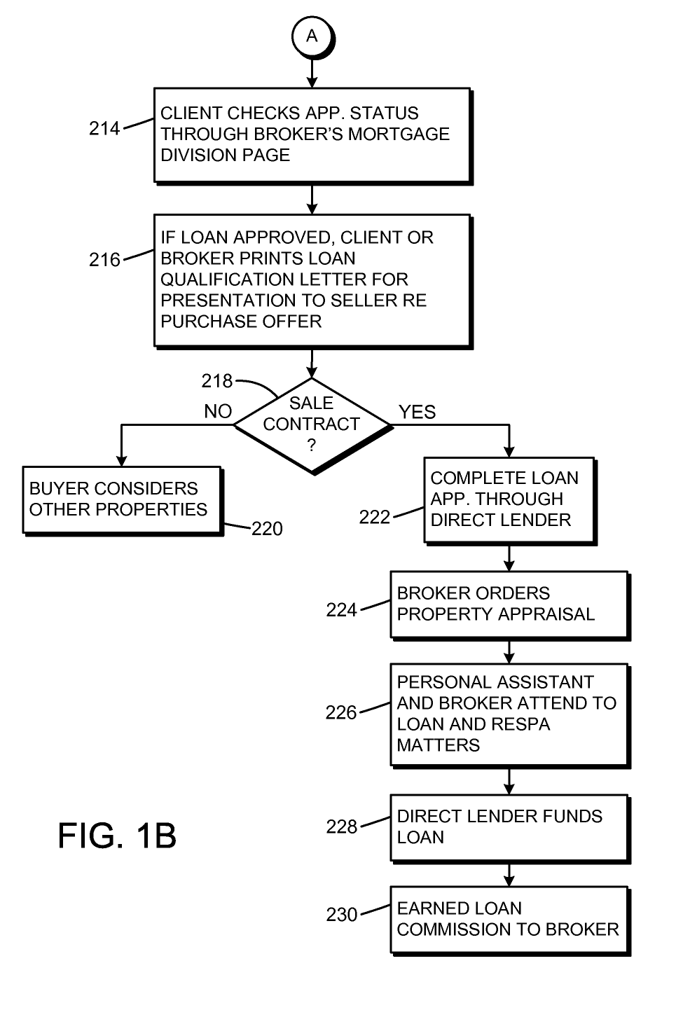

FIG. 1 depicts diagrammatically an exemplary embodiment of a mortgage origination system 10. In an embodiment of the mortgage origination system, the Originator may enter into an arrangement with a direct lender to act as a wholesale broker for the direct lender 40. Typically, the direct lender may be a lender which makes loans with its own money, and may resell the loans on the market. The direct lender may provide, under this arrangement, services such as website services, whereby a mortgage division button 24 is placed on the home page 22 of the Originator's website 20, and a Splash Page 26 is provided, with loan information 28 and a link to an abbreviated loan application 30. A direct lender may provide loan processing, loan underwriting, document drawing and funding functions in originating and closing loan transactions. The direct lender may sell loans which it has originated on a secondary market.

The direct lender also assigns the Personal Assistant for the Originator. The Personal Assistant may be employed by the direct lender. The Personal Assistant may be highly trained in the load origination business.

In an exemplary embodiment, the Originator may be a real estate broker or agent working through a licensed broker. The Originator broker in this example may have a client who is a prospective buyer of a certain real estate property, e.g. residential property. The client may typically wish to know that he or she will be able to obtain financing of a loan secured by the property before submitting a purchase offer. Sometimes this can be accomplished by a prequalification by a lender for a certain loan amount based on the client's financial position. In the past, the broker may have referred the client to a mortgage broker or to a direct lender for qualification. In this case, the Originator broker would have no control over the loan process, and would not typically be entitled to receive a loan fee or commission.

Rather than sending the client to a mortgage broker, for no fee, the Origination broker may direct the client/prospective buyer to the Originator broker's website 20 with instructions to click on the mortgage division button 24. The client navigates to the website, e.g. using a web browser operating on the client's computer system 50, and clicks on the mortgage division button 24. This begins a process for the Originator broker to maintain involvement in the transaction and to earn a loan fee or commission.

Once clicked, the “mortgage division” button opens the “Splash Page” 26 on the Originator broker's website 20. From this “Splash Page” the client can get information on financing, diagrammatically depicted as 28, and click on the loan application button 30 to apply on-line for a loan or loan qualification.

In an exemplary embodiment, the loan application is an abbreviated application that gathers enough information to render an automated decision while providing a loan professional, e.g. in an exemplary embodiment the “Personal Assistant,” assigned by the direct lender to the Originator broker, sufficient information to make contact with the borrower for application proofing and for adding any information necessary through an initial interview process. Thus, not only is there an automated component to the loan qualification process once the loan application is submitted, but also a human component, through assignment of a Personal Assistant, i.e., a human person with responsibility in closing a client's loan.

The quick loan application, when completed by the client, is submitted on-line to the direct lender server 42 over an internet connection. It will be appreciated that the data transfer is conducted securely. When received on the server 42, it may then be processed by the direct lender to obtain prequalification or approval. In this processing, the Personal Assistant is involved in the loan application processing to ensure the completeness of the application for the intended purpose, e.g. prequalification or loan approval. The client is able to login through the Originator broker's website to a secured database on the server 42 using login information setup when he or she submitted the quick loan application. When the direct lender has made a decision on the loan application, a decision letter, e.g. a prequalification letter, may be posted to the database, and is then available for downloading by the client, or by the Originator broker in one embodiment.

In an exemplary embodiment, as noted above, the Originator broker may be assigned a Personal Assistant by the direct lender. This “Personal Assistant“may be a highly trained professional who may download the application, contact the client/prospective borrower for missing information and discuss their needs, pull a credit report, review the client's needs with the Originator broker, recommend loan programs and assist the Originator broker in quoting rates. Thus, a communication link may be provided between the client and Originator broker and the Personal Assistant assigned by the direct lender. The Personal Assistant may subsequently, e.g. when a loan is approved, work directly with the client/borrower, the Originator broker, as well as in some applications the underwriter and the escrow officer to close the transaction.

The qualifications, duties and responsibilities of the Personal Assistant in an exemplary embodiment may substantially higher than that of a normal loan processor. The Personal Assistant may be responsible for receiving incoming loan packages, preparing them for processing, recording HMDA (Home Mortgage Disclosure Act) data, and assisting other loan production team members as needed. For example, the Personal Assistant may perform some or all of the following functions:

Logs new loan submissions from the processing center into the loan origination software (LOS) with accurate information, prepares file label, and date stamps the loan file.

Logs loan file into the daily log.

Prepares the loan file.

Notes which documents are in package by checking appropriate items on an Application Checklist.

Sends original application to client/borrowers with disclosures and estimated closing statement.

Makes client/borrowers aware of necessary documentation needed for a full loan application and explains the loan submission and approval process.

Inputs all new files into the direct lender's LOS.

Generates a three-file merge credit report if one is not provided and notes such in appropriate log.

Orders an appraisal review and notes such in appropriate log.

Logs in delivered loan conditions and distributes them to the appropriate personnel for review.

Insures that HMDA information is recorded in the LOS.

Gathers all documentation and third party related documents for loan funding

Reviews received loan documentation to ensure applicant's eligibility for designated programs and that the files are complete and accurate.

Works closely with brokers, underwriters, loan processors and others to resolve any conditions that may adversely affect final approval consideration.

Signs off on loan conditions within approval authority.

Recommends appropriate underwriting exceptions.

Follows-up on conditions issued at approval and prior to funding; communicates and negotiates any eligibility changes that may affect rate and/or program.

Maintains prompt follow-up and tracking of all necessary documentation/fees.

Reviews all pre-disclosures, monitors and maintains regulatory compliance and compliance of company policies and procedures.

Reviews HMDA data for accuracy on loans approved but not accepted, withdrawn or closed for incompleteness.

Monitors and maintains updated information on LOS ensuring data is consistent with documentation received.

Manages loan pipeline to facilitate and expedite approval and funding; keeps appropriate people aware of when loans will fund.

Assists in preparation of loan applications for customers and discusses customer's expectations of loan process, answering questions, and helping the customer feel comfortable with the process.

Conducts preliminary underwriting reviews, credit analyses, and submits loan applications to processing.

Remains front line contact with client/borrower and others for follow up documentation needed to approve and close loans.

Uses LOS to enter and update loan information in a timely manner.

Maintains, develops, and has a thorough understanding of the direct lender's loan programs, guidelines, etc.

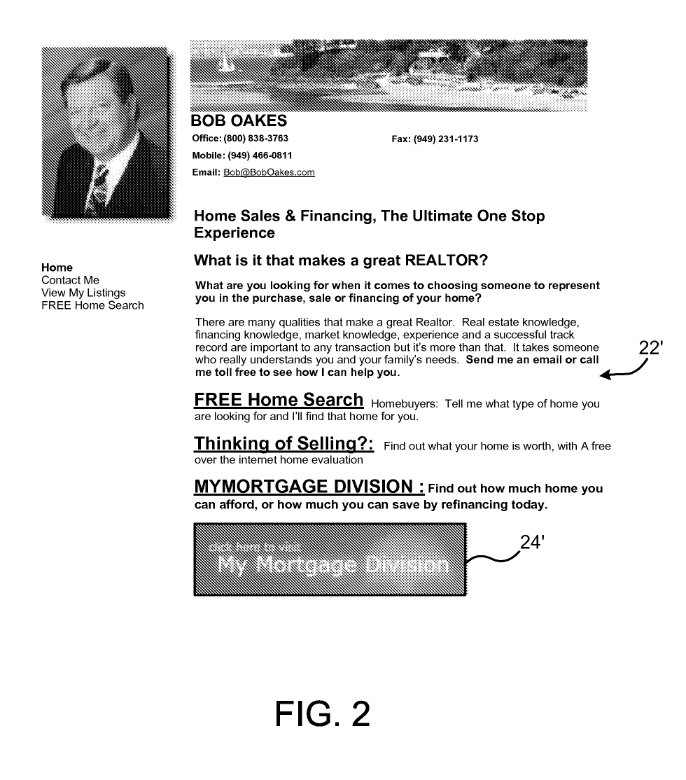

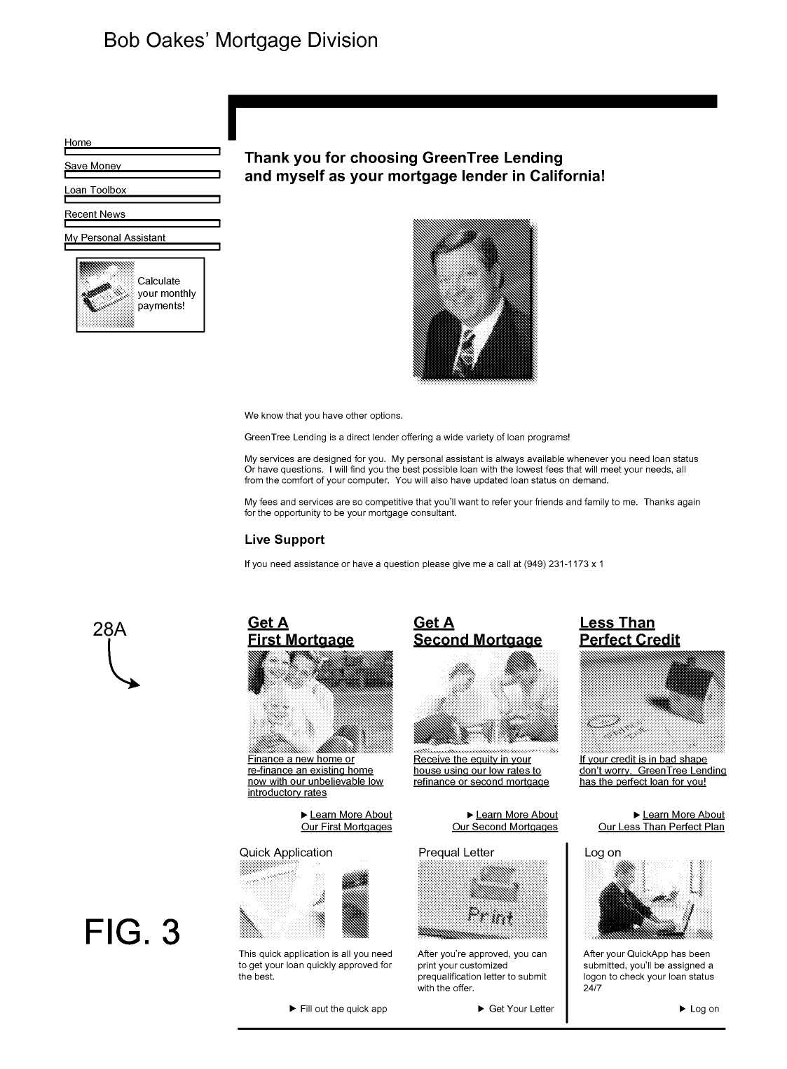

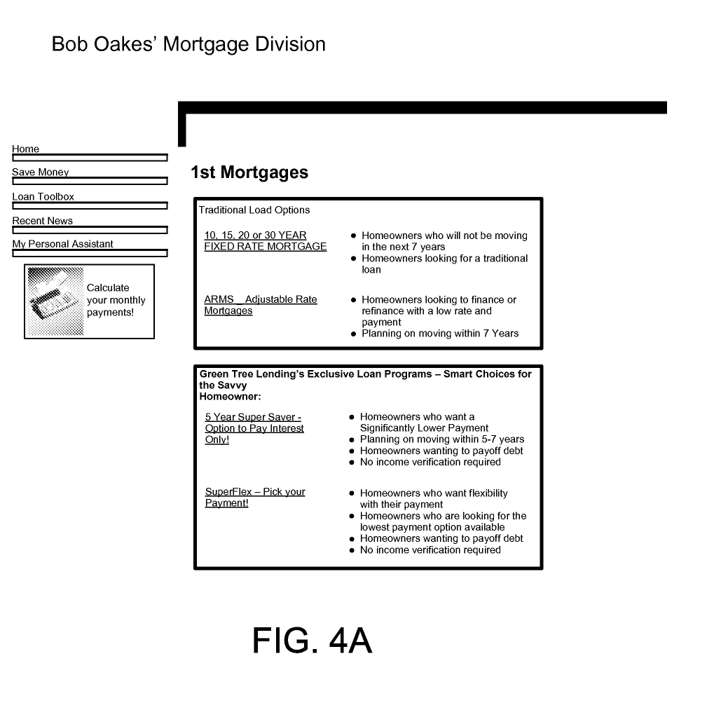

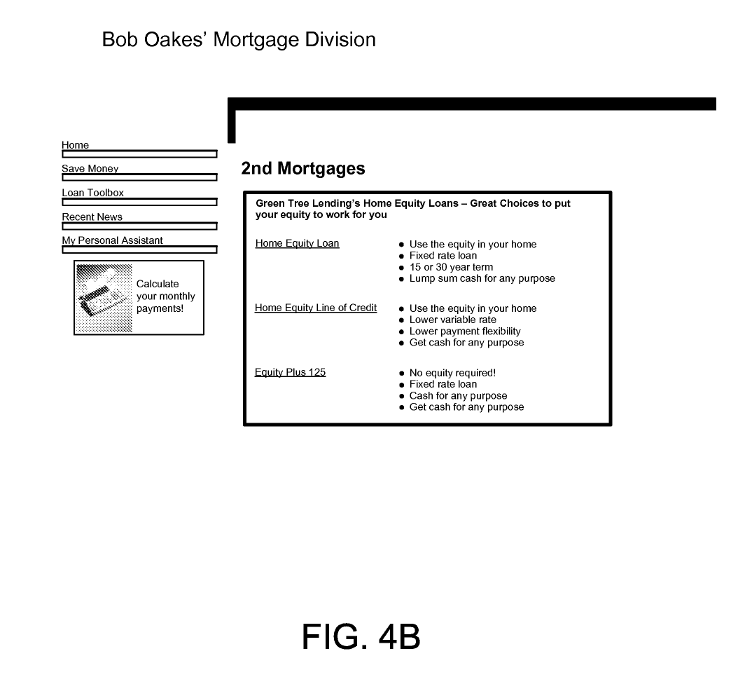

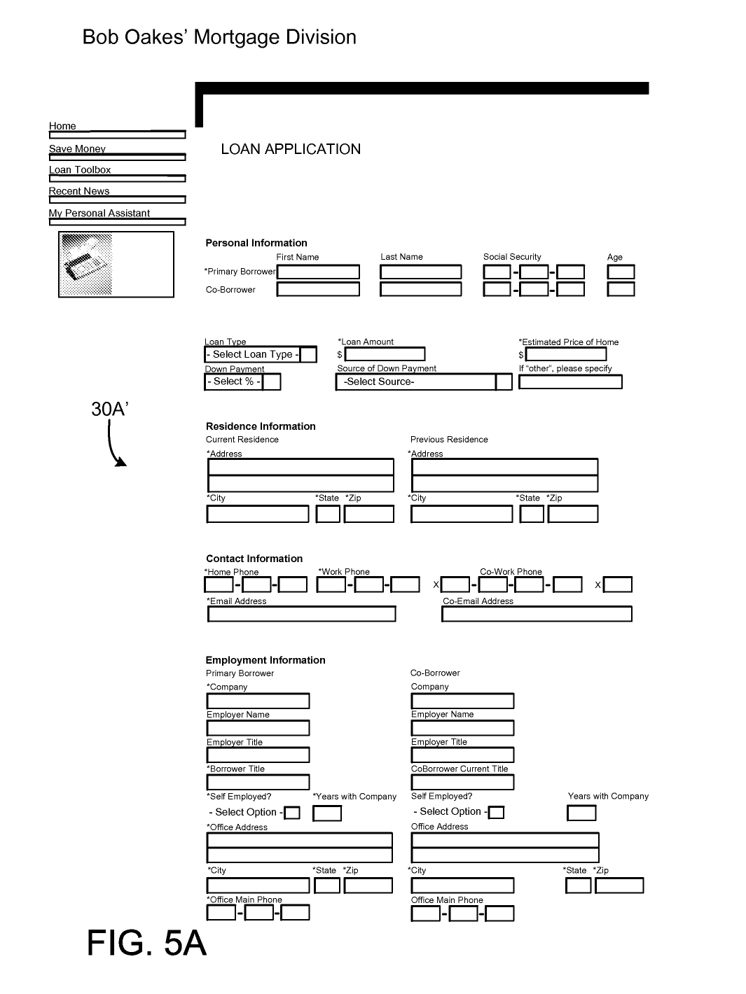

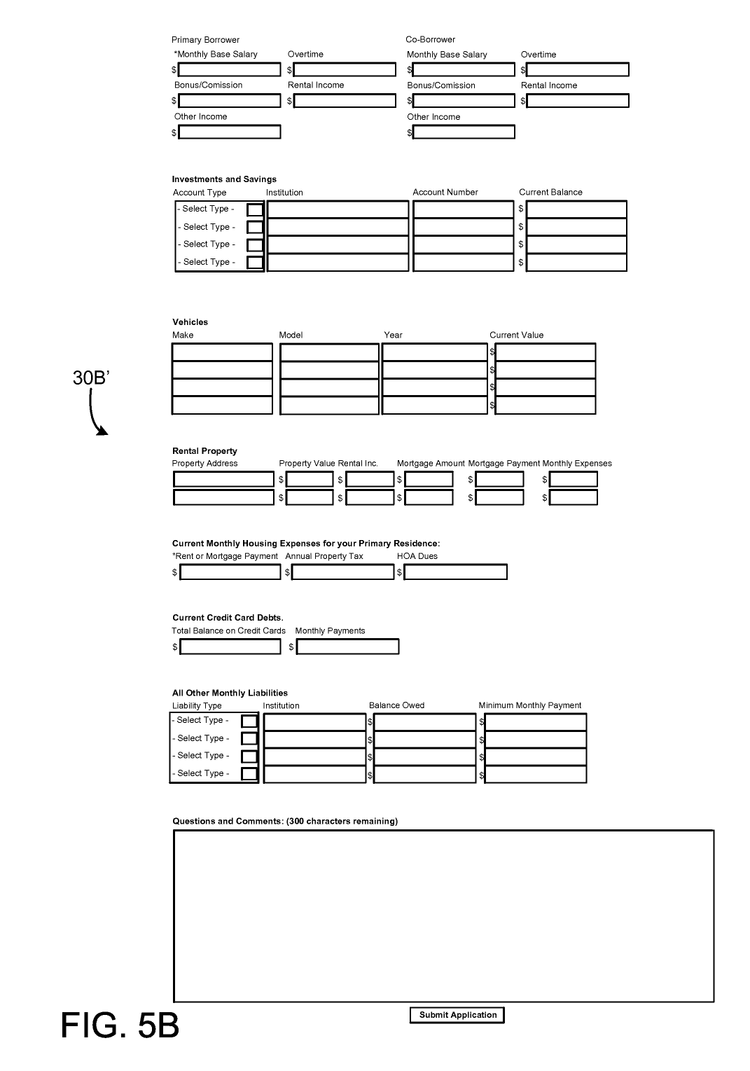

FIGS. 1A-1B illustrate an exemplary flow diagram of an exemplary loan origination process, for the case in which the Originator is a real estate broker. FIGS. 2-5C are exemplary screen shots which may be generated by a loan origination system as depicted in FIG. 1. Referring now to FIGS. 1A-1B, the client navigates (step 202) to the broker's website using a computer system connected to the internet. An exemplary home page 22′ for a broker is depicted in the screen shot of FIG. 2. In addition to information about the broker, the home page has placed thereon an active button 24′, the mortgage division button. Say for example that the client is interested in making an offer to purchase a residential property. The broker may instruct the client to click on the button 24′ (step 204) for obtaining loan information, and to apply on-line for loan prequalification. FIGS. 4A-4B are screen shots depicting exemplary loan information provided by the direct lender. Clicking on the loan application button (step 206) opens a page with an on-line loan application. FIGS. 5A-5C depict screen shots of an exemplary on-line loan application with three pages 30A′-30C′. Once the application is completed, the client clicks on a submit button, and the application is transmitted over the internet to the direct lender's server for processing (step 208). The application may be reviewed by the Personal Assistant, and he/she may contact the client for information (step 210). The direct lender makes a decision on the quick loan application (step 212), which may be a decision to pre-qualify the client for a loan of a certain amount subject to final conditions.

A decision letter, e.g. a qualification letter, may be posted to a server database, which may be accessed by the client using his/her login data (step 214) while checking online status of the application. If the loan has been approved, or pre-qualified in this example, the letter may be printed and presented to the property seller regarding the client's offer to purchase the property (step 216). In the course of negotiations, the client and seller may or may not enter into a sales contract, whereby the client is to purchase the property for an agreed consideration (step 218). If no contract is entered into, the buyer may consider other properties (step 220). However, in the event a sales contract is entered into, then the client may proceed to close the loan through the direct lender. In this case, the loan application may be completed (step 220), the broker may order an appraisal (step 222). The personal assistant and the broker may attend to gathering any further information needed to close the loan, and to state and federal regulatory requirements, (e.g. RESPA requirements) (step 224). Once all contractual and regulatory matters have been addressed, the direct lender funds the loan (step 226), the sale is closed. The Originator broker may then receive an agreed, earned commission, compatible with regulatory requirements such as RESPA.

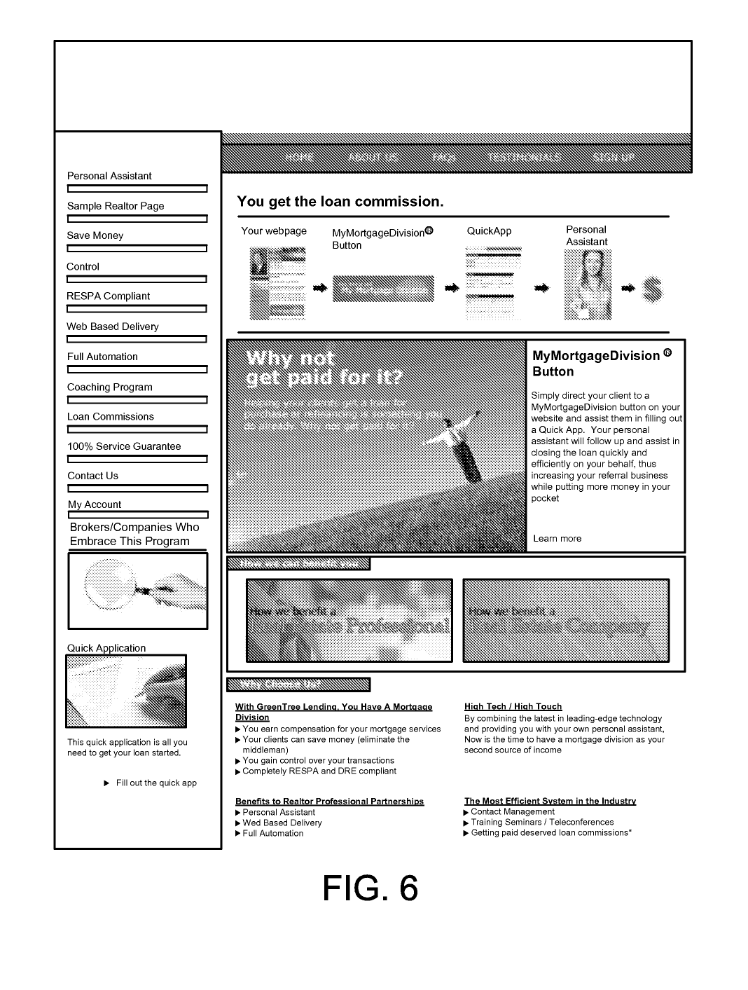

FIG. 6 is a representative screen shot generated by an exemplary embodiment of a direct lender's website describing features of a loan origination program and system.

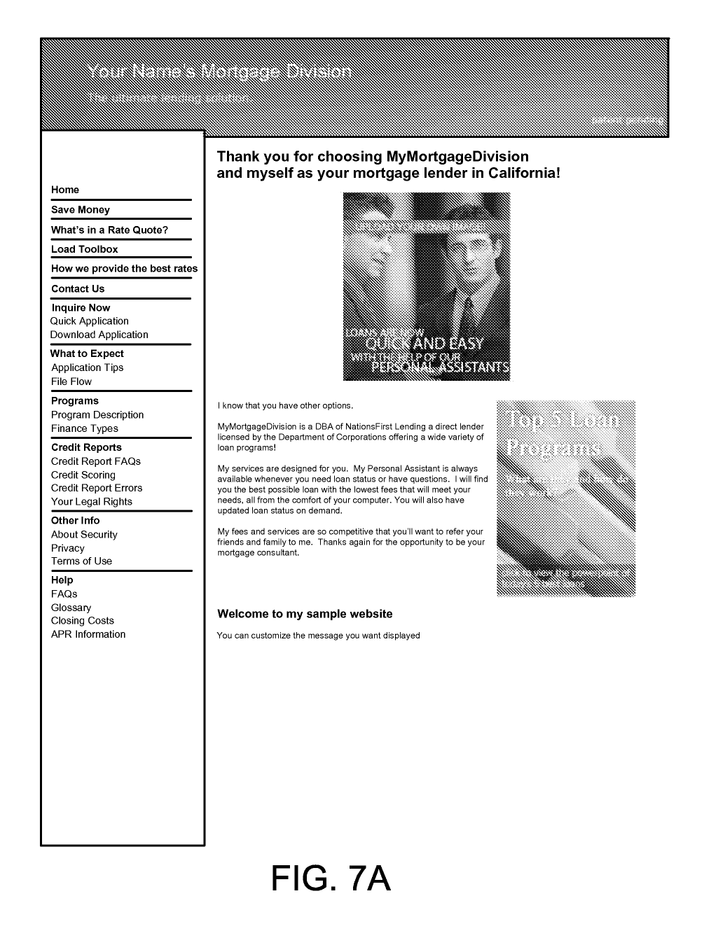

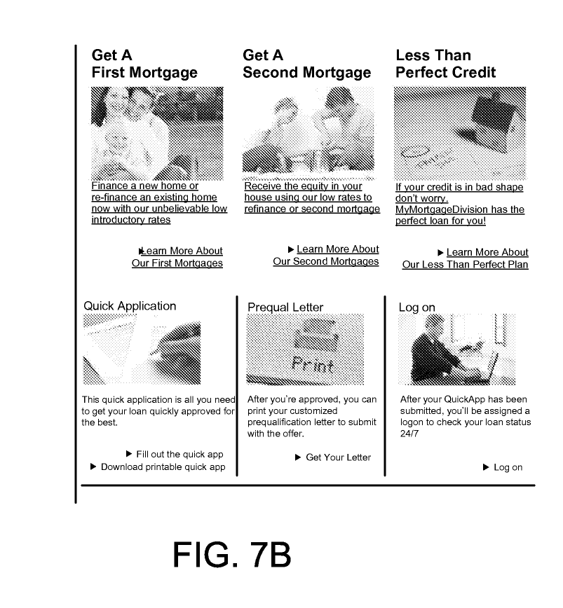

FIGS. 7A-7B are representative screen shots of an exemplary embodiment of a sample loan originator mortgage division website page. Links are provided on this example page to an abbreviated loan application, to status, and to information about available loan products and programs.

An exemplary embodiment of a loan origination process flow may include the process steps set out in Table 1.

TABLE I

| Step | Activity | Completed by |
|---|---|---|
| Inquiry | Inquiries are received via online web application. | Realtor/Borrower |
| Inquiry | Personal Assistant contacts Client to review needs | Personal |
| | and desires as well as to complete any missing | Assistant |
| | information on loan application. | |
| Inquiry | Credit report and request for value (if refinance) is | Personal |
| | ordered. Qualified inquiries are forwarded to an | Assistant |
| | underwriter where an underwriting assessment is | |
| | made or it is determined further information is | |
| | required. | |
| Inquiry | Loan conditions are determined and provided to | Personal |
| | Client and Originator with completed application | Assistant |
| | and disclosures via e-mail within 24 hours. | |
| Application | Obtain signatures on residential loan application/ | Agent |
| | disclosures, Appraisal Fee and loan conditions. | |
| | Originator forwards documents and conditions to | |
| | Direct Lender. | |
| Processing | Underwriter reviews loan documents, conditions | Underwriter |
| | and interest rate. Loan status sheet and Mortgage | |
| | Rate Lock Disclosure confirmation (if rate is | |
| | locked) are forwarded to Client and Originator. | |
| Processing | Appraisal is ordered by Originator, using the | Originator, |
| | appraisal form determined by the Automated | Personal |
| | Underwriting approval. Client is notified via e-mail | Assistant |
| | when value is in. | |
| Processing | Title Report, Lien check(s), copy of proposed | Personal |
| | conveyance document and Tax information | Assistant |
| | worksheet are ordered by processor from an | |
| | approved escrow/title company. Client and | |
| | Originator are notified via e-mail. | |
| Processing | Upon receipt, Title Report and Appraisal are | Underwriter |
| | reviewed by underwriter. | |
| Processing | Mortgage Insurance certificate and condominium | Personal |
| | disclosures are obtained (if required). | Assistant |
| Processing | Loan conditions are cleared by the underwriter and | Personal |
| | the investor (if required). | Assistant |
| Processing | Flood check is completed. Flood zone disclosure is | Personal |
| | issued to applicant and Flood insurance is ordered | Assistant |
| | if required. Originator is notified via e-mail if the | |
| | subject property is in a flood zone. | |
| Processing | Personal Assistant informs Client and Originator | Personal |
| | via e-mail of loan approval, closing conditions and | Assistant |
| | interest rate (if it has not been locked). | |
| Processing | Signing, funding, and recording dates, signing | Originator |
| | location, and interest rate/points are confirmed with | |
| | Client along with any outstanding closing | |
| | conditions. Client is notified via e-mail by Originator | |
| | and the Personal Assistant. | |
| Processing | Hazard insurance binder is ordered. The hazard | Personal |
| | Insurance request will reflect for the binder to be | Assistant |
| | faxed and mailed to the Closing department. | |
| | Originator is notified via e-mail. | |
| Closing | Doc Drawer prepares preliminary figures and | Doc Drawer |
| | closing documents and then internally proofs loan | |
| | documents to ensure accuracy. | |
| Closing | Doc Drawer sends preliminary figures to escrow. | Doc Drawer |
| | Escrow will forward a tentative HUD-1 settlement | |
| | statement to the closing department. Doc Drawer | |
| | then prepares and forwards loan package to | |
| | escrow agent for signing | |
| Closing | Obtain Client's signatures and notary on closing | Escrow Officer |
| | documents. Return documents and closing | |
| | conditions to Direct Lender no later than the | |
| | following day. | |
| Closing | Upon receipt of signed loan package, Closing | Funder |
| | department conducts post-closing audit and | |
| | ensures documents are signed correctly and all | |
| | conditions have been met and orders wire transfer | |
| | to fund Client's loan. Client and Originator will be | |
| | notified by phone and email when loan funds. | |
| Closing | Title records information at country recorders office | Title and Escrow |
| | and then notifies escrow. Escrow then informs | Officers |
| | Client and Originator that transaction has closed. | |

A disclosure may be made to the client that the originator has a wholesale relationship with the direct lender, and may be paid a commission if the loan is closed through the direct lender. The loan originator may certify to completion of certain tasks, e.g. tasks defined by a governmental agency, e.g. in RESPA, in the event a commission has been earned.

Although the foregoing has been a description and illustration of specific embodiments of the subject matter, various modifications and changes thereto can be made by persons skilled in the art without departing from the scope and spirit of the subject matter, as defined in the following claims.

What is claimed is:

1. A loan origination system, comprising:
a special button placed on a real estate sale professional's website;
a loan web page linked to the special button, the web page including with a loan application button provided by a direct lender; and
an abbreviated loan application which is accessed from the web page, and submitted on-line by a client to the direct lender that gathers enough information to make contact with the client for application proofing and for adding additional information through an initial interview process.

2. The system of claim 1, further including:
a communication link to a loan processor person provided by the direct lender and assigned to the loan Originator.

3. The system of claim 1, wherein the loan application is for a loan to be secured by a real estate property.

4. The system of claim 1, further comprising a loan application status communication link accessed through said website for the client to obtain status information regarding the load application.

5. A computer-assisted method for originating a mortgage loan process for a real estate property, comprising:
using a web browser to navigate to real estate sale professional's website home page;
from a link maintained on home page of said website, navigating to a mortgage loan page of said website, said mortgage loan page including loan option information regarding different types of available loan products;
from said mortgage loan page of said website, opening a link to an abbreviated loan application that gathers enough information to make contact with a client for application proofing and for adding additional information through an initial interview process;
setting up a client login;
entering a client's application information into said abbreviated loan application to provide a completed abbreviated loan application originated from the real estate sale professional's website;
transmitting said completed abbreviated loan application via an internet connection to a server maintained by the direct lender;
processing said completed abbreviated loan application by the direct lender to render an approval decision or collect additional information from the client, said processing including downloading the abbreviated loan application by a loan processor person assigned by the direct lender to the real estate broker, and contacting the client to collect additional information needed in a loan approval by the direct lender or by an underwriter.

6. The method of claim 5, further comprising:
posting a decision by the direct lender to the direct lender server;
using said client login to access said decision posted to the direct lender server through the real estate sale professional's website.

7. The method of claim 5, wherein said loan approval decision is a loan qualification decision, and further comprising:
ordering an appraisal of the real estate property, and attending to loan and regulatory matters, including participation by the real estate sale professional in a plurality of said matters;
funding a loan on the real estate property as a result of said loan application submitted through said real estate sale professional's website;
providing an earned loan commission to the real estate sale professional in accordance with a governmental regulation.

8. The method of claim 5, wherein said loan option information included on said mortgage loan page includes first mortgage loan options for a plurality of terms and for fixed rate and adjustable rate loans.

9. The method of claim 5, wherein said loan option information included on said mortgage loan page includes second mortgage loan options including home equity loan information for a fixed term and home equity line of credit information.

10. The method of claim 5, wherein said link to an abbreviated loan application is maintained by the direct lender.

11. The method of claim 5, wherein said loan processor person is an employee of the direct lender.

12. A computer-assisted method for originating a mortgage loan process for a real estate property, comprising:
using a web browser to navigate to a real estate sale professional's website;
from a link maintained on home page of said website, navigating to a mortgage loan page of said website, said mortgage loan page including loan option information regarding different types of available loan products;
from said website, opening a link to an abbreviated loan application that gathers enough information to make contact with the client for application proofing and for adding additional information through an initial interview process;
entering a client's application information to provide a completed abbreviated loan application originated from said website;
transmitting said completed abbreviated loan application via an internet connection to a server maintained by the direct lender;
processing said completed abbreviated loan application by the direct lender to render an approval decision or collect additional information from the client, said processing including downloading the abbreviated loan application by a loan processor person assigned by the direct lender to the real estate sale professional, and contacting the client to collect additional information needed in a loan approval by the direct lender or by an underwriter.

13. The method of claim 12, further comprising:
posting a decision by the direct lender to the direct lender server;
accessing said decision posted to the direct lender server through the real estate sale professional's website.

14. The method of claim 12, further comprising:
ordering an appraisal of the real estate property, and attending to loan and regulatory matters, including participation by the real estate sale professional in a plurality of said matters;
funding a loan on the real estate property as a result of said loan application submitted through said real estate sale professional's website;
providing an earned loan commission to the real estate sale professional in accordance with a governmental regulation.

15. The method of claim 12, wherein said loan option information includes first mortgage loan options for a plurality of terms and for fixed rate and adjustable rate loans.

16. The method of claim 12, wherein said loan option information includes second mortgage loan options including home equity loan information for a fixed term and home equity line of credit information.

17. The method of claim 12, wherein said link to an abbreviated loan application is maintained by the direct lender.
